(19) United States
(12) Patent Application Publication
(10) Pub. No.: US 2023/0298469 A1
(43) Pub. Date: Sep. 21, 2023

(54) APPARATUS AND METHOD FOR COOPERATIVE ESCAPE ZONE DETECTION

(71) Applicant: Toyota Motor Engineering & Manufacturing North America, Inc., Plano, TX (US)

(72) Inventors: Rohit GUPTA, Santa Clara, CA (US); Ziran WANG, San Jose, CA (US); Kyungtae HAN, Palo Alto, CA (US); Prashant TIWARI, Santa Clara, CA (US)

(73) Assignee: Toyota Motor Engineering & Manufacturing North America, Inc., Plano, TX (US)

(21) Appl. No.: 17/509,711

(22) Filed: Oct. 25, 2021

(51) Int. Cl. G08G 1/00; G01C 21/34; B60W 50/00

(52) U.S. Cl. CPC G08G 1/207; B60W 50/00; G01C 21/3415; B60W 2050/0005; B60W 2555/20; B60W 2556/50; B60W 2556/65; B60W 2756/10

(57) ABSTRACT

A system including sensors and a controller for cooperative escape zone detection for a group of vehicles are provided. The sensors obtain driving condition information indicating driving environments and vehicle conditions for the group of vehicles. For each vehicle, the controller determines, based on the driving environment of the vehicle, one or more distances associated with the vehicle that are between the vehicle and one or more obstacles that surround the vehicle and determines an escape zone status for the vehicle based on the one or more distances and the driving environment and the vehicle condition of the vehicle. When the escape zone status of one in the group of vehicles fails to satisfy a pre-defined condition, the controller sends one or more control signals to one or more vehicles in the group of vehicles to create an additional escape zone for the one in the group of vehicles.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

A vehicle can be configured to have a navigation system. In an example, U.S. 6415226 B1 describes a feature for a motor vehicle that includes a navigation system and one or more safety systems that detect an area around the vehicle. The feature advises the vehicle driver to travel along roads that are represented by data that enables operation of the one or more safety systems.

### SUMMARY

According to an embodiment of the present disclosure, a system and a method for cooperative escape zone detection for a group of vehicles are provided. The system includes sensors and a controller. The sensors are configured to obtain driving condition information for the group of vehicles. The driving condition information indicates driving environments and vehicle conditions of the group of vehicles. For each vehicle in the group of vehicles, the controller is configured to determine, based on the driving environment of the vehicle, one or more distances associated with the vehicle that are between the vehicle and one or more obstacles that surround the vehicle. For each vehicle in the group of vehicles, the controller is configured to determine an escape zone status for the vehicle based on the one or more distances associated with the vehicle, the driving environment of the vehicle, and the vehicle condition of the vehicle. The escape zone status indicates whether one or more escape zones are available to the vehicle. In response to the escape zone status of one in the group of vehicles failing to satisfy a pre-defined condition, the controller sends one or more control signals to one or more vehicles in the group of vehicles to instruct the one or more vehicles to create an additional escape zone for the one in the group of vehicles.

In an embodiment, the vehicle condition of the vehicle comprises one or more of a brake condition, a tire condition, and a speed of the vehicle.

In an embodiment, the driving environments include one or more of at least one road condition, at least one road type, and a weather condition for the group of vehicles. The controller is further configured to determine a threshold distance based on one or more of a respective one of the at least one road condition, a respective one of the at least one road type, the weather condition, and the vehicle condition for the vehicle and determine whether the one or more escape zones are available to the vehicle based on a comparison of the one or more distances and the threshold distance.

In an example, each vehicle in the group of vehicles is associated with four sides that include a front side, a rear side, a left side, and a right side, the one or more obstacles includes a front obstacle, a rear obstacle, a left obstacle, and a right obstacle, the one or more distances associated with the vehicle include a front distance, a rear distance, a left distance, and a right distance between the vehicle and the front obstacle, the rear obstacle, the left obstacle, and the right obstacle, respectively. For each vehicle in the group of vehicles, the controller is further configured to determine whether the escape zone is available for each of the four sides based on a comparison of the front distance, the rear distance, the left distance, and the right distance with the threshold distance and determine the escape zone status that indicates a number of escape zones available to the vehicle and/or a location of an escape zone.

In an example, the group of vehicles travels on at least one road, the at least one road condition of the at least one road indicates one of: dryness, quality, or curvature of the at least one road, and the at least one road type of the at least one road indicates at least one speed limit of the at least one road.

In an example, the pre-defined condition comprises one or more of (i) a number of escape zones for each of the group of vehicles exceeds a threshold number, or (ii) one or more locations of the one or more escape zones are located at pre-defined locations.

In an example, the one or more vehicles includes a plurality of vehicles in the group of vehicles, the one or more control signals includes a plurality of signals of the plurality of vehicles, and the controller is further configured to send the plurality of signals to the plurality of vehicles, respectively.

In an example, the one or more vehicles comprises the one in the group of vehicles.

In an example, the controller is further configured to determine the one or more distances using an artificial neural network. The system further includes interface circuitry configured to obtain a training dataset including driving condition information of multiple vehicles and corresponding distances associated with each of the multiple vehicles. The corresponding distances are between the vehicle and obstacles that surround the vehicle. The controller is further configured to modify the artificial neural network based on the training dataset.

In an example, the system further includes a centralized controller having another artificial neural network. The controller is configured to update the artificial neural network in the controller based on the other artificial neural network.

In an example, the controller is one of (i) a centralized controller in a cloud or (ii) a decentralized controller associated with the group of vehicles. In an example, the controller is the centralized controller in the cloud, the system further includes a decentralized controller associated with the group of vehicles, and the decentralized controller is configured to preprocess the driving condition information to obtain the driving environments and the vehicle conditions of the group of vehicles.

According to aspects of the disclosure, the method includes obtaining, by a controller configured for the cooperative escape zone detection for the group of vehicles, driving condition information for the group of vehicles, the driving condition information indicating driving environments and vehicle conditions of the group of vehicles. For each vehicle in the group of vehicles, the method includes determining, based on the driving environment of the vehicle, one or more distances associated with the vehicle that are between the vehicle and one or more obstacles that surround the vehicle and determining an escape zone status for the vehicle based on the one or more distances associated with the vehicle, the driving environment of the vehicle, and the vehicle condition of the vehicle. The escape zone status indicates whether one or more escape zones are available to the vehicle. In response to the escape zone status of one in the group of vehicles failing to satisfy a pre-defined condition, the method includes sending one or more control signals to one or more vehicles in the group of vehicles to instruct the one or more vehicles to create an additional escape zone for the one in the group of vehicles.

According to an embodiment of the present disclosure, there is provided a non-transitory computer readable storage medium having instructions stored thereon that when executed by processing circuitry causes the processing circuitry to perform the method.

### BRIEF DESCRIPTION OF THE DRAWINGS

Various embodiments of this disclosure that are proposed as examples will be described in detail with reference to the following figures, wherein like numerals reference like elements, and wherein:

FIG. 1A shows an exemplary cooperative escape zone system 100 for a group of vehicles according to an embodiment of the disclosure.

FIG. 1B shows an example of a sub-system 191 according to an embodiment of the disclosure.

FIG. 2 shows an example of detecting escape zone information for a group of vehicles on a highway according to an embodiment of the disclosure.

FIG. 3 shows an example of an escape route 301 according to an embodiment of the disclosure.

FIG. 4 shows an example of detecting escape zone information in a residential area according to an embodiment of the disclosure.

FIG. 5 shows an example of detecting escape zone information on a highway according to an embodiment of the disclosure.

FIG. 6 shows an example of detecting escape zone information in mountainous driving according to an embodiment of the disclosure.

FIG. 7 shows a flowchart outlining an exemplary process 700 according to an embodiment of the disclosure.

FIGS. 8A-8B show an example of cooperative escape zone determination for a group of vehicles according to an embodiment of the disclosure.

FIG. 9A is a flowchart outlining an exemplary process 900A according to an embodiment of the disclosure.

FIG. 9B is a flowchart outlining an exemplary process 900B according to an embodiment of the disclosure.

FIG. 10A is a flowchart outlining an exemplary process 1000A according to an embodiment of the disclosure.

FIG. 10B is a flowchart outlining an exemplary process 1000B according to an embodiment of the disclosure.

FIG. 11A is a flowchart outlining an exemplary process 1100A according to an embodiment of the disclosure.

FIG. 11B is a flowchart outlining an exemplary process 1100B according to an embodiment of the disclosure.

### DETAILED DESCRIPTION

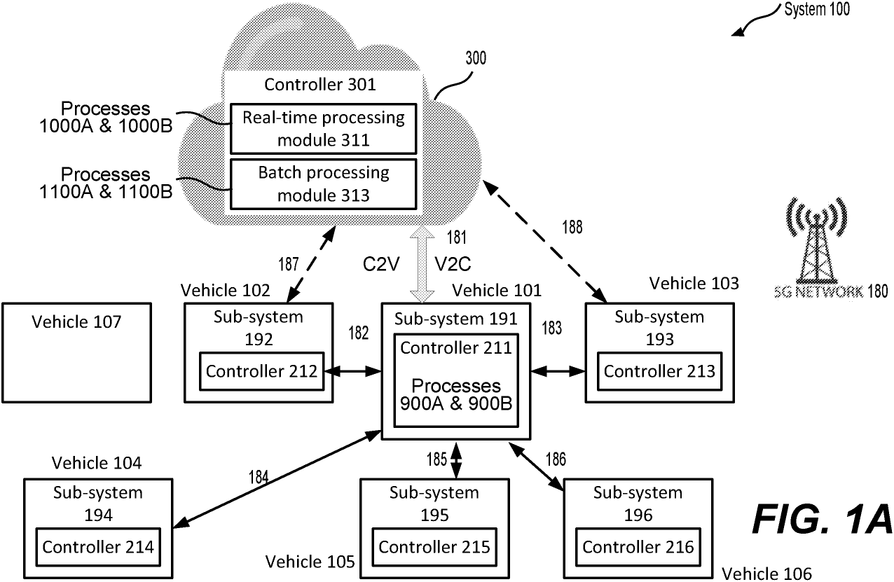

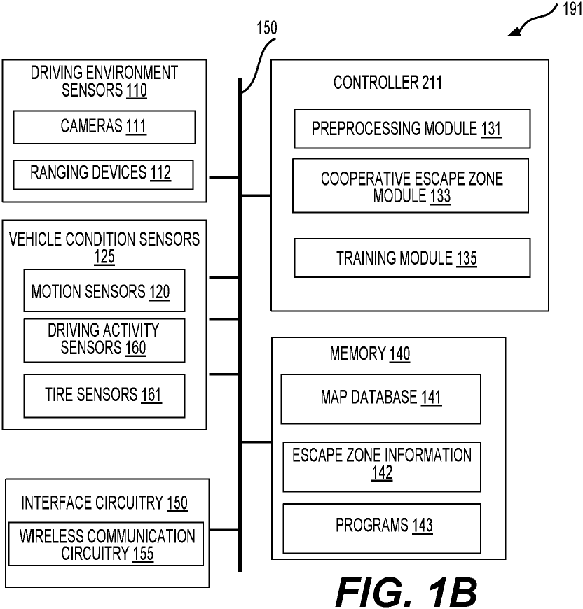

FIG. 1A shows an exemplary cooperative escape zone system 100 (or system 100) for a group of vehicles, such as vehicles 101-106, according to an embodiment of the disclosure. The system 100 can be configured to detect and/or predict escape zone information for the group of vehicles (e.g., the vehicles 101-106). The group of vehicles (e.g., the vehicles 101-106) can be any type of vehicle, such as vehicles powered by electricity, gas, and/or the like. The escape zone information for the group of vehicles (e.g., the vehicles 101-106) can indicate escape zone statuses for the group of vehicles (e.g., the vehicles 101-106). For example, an escape zone status of the vehicle 101 indicates that escape zones are available on the left side and in front of the vehicle 101, and no escape zones are available on the right side of and behind the vehicle 101. Further, the system 100 can be configured to send control signal(s) to one or more vehicles in the group of vehicles to instruct the one or more vehicles to create additional escape zone(s) for one in the group of vehicles. Alternatively, the escape zone information for the group of vehicles (e.g., the vehicles 101-106) can indicate escape zone(s) for the group of vehicles (e.g., the vehicles 101-106).

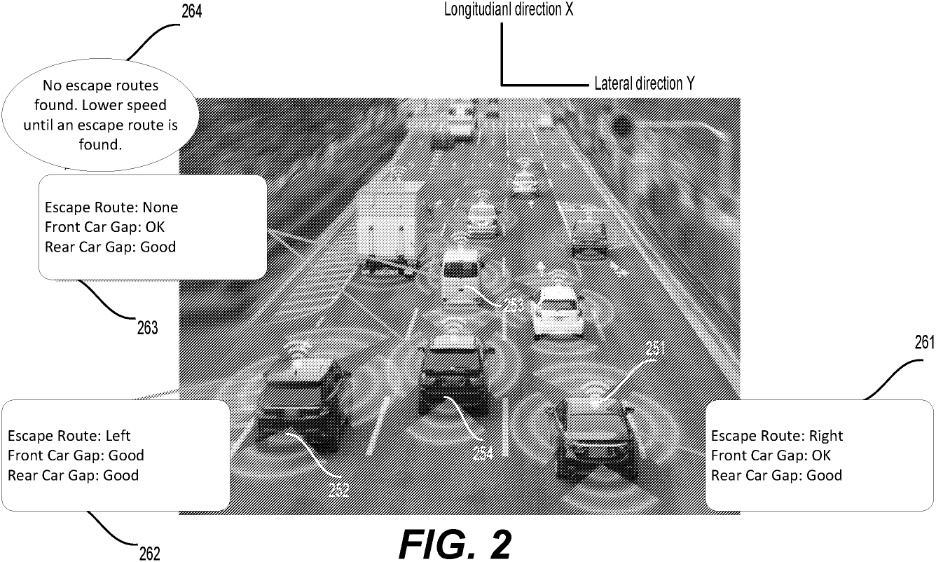

An escape zone, an escape route, and a vehicle distance (or a vehicle) gap can be described below with reference to FIG. 2. FIG. 2 shows an example of detecting escape zone information for a group of vehicles on a highway according to an embodiment of the disclosure. A vehicle distance (or a vehicle gap) can refer to a gap or a distance between a vehicle and an obstacle that surround the vehicle. The obstacle can be another vehicle, a road block, a road construction, a road kill, or the like. Referring to FIG. 2, the vehicle distance can be along a longitudinal direction X that is parallel to a driving direction of a vehicle, and thus the vehicle distance can be referred to as a front vehicle distance (or a front distance, a front vehicle gap, a front gap) that is in front of the vehicle or a rear vehicle gap (or a rear distance, a rear vehicle gap, a rear gap) that is behind the vehicle. The vehicle distance can be along a lateral direction Y that is perpendicular to the longitudinal direction X, and thus the vehicle distance can be referred to as a left vehicle distance (or a left distance, a left vehicle gap, a left gap) that is to the left of the vehicle or a right vehicle distance (or a right distance, a right vehicle gap, a right gap) that is to the right of the vehicle.

According to an embodiment of the disclosure, an escape zone is available to the vehicle or the vehicle has an escape zone when a vehicle distance satisfies a condition. In an example, the escape zone is available to the vehicle or the vehicle has an escape zone when the vehicle distance is larger than a threshold distance. For example, the vehicle distance or the vehicle gap is classified as “Good” when the vehicle distance is larger than the threshold distance. The vehicle distance or the vehicle gap is classified as “OK” or “Comprised” when the vehicle distance is equal to the threshold distance. Additional or other types of classification types can be used.

In some examples, when the escape zone is lateral to the vehicle, for example, the escape zone is to the left or to the right of the vehicle, the escape zone is referred to as an escape route. The vehicle can move to the escape route, for example, in case of an emergency.

Referring back to FIG. 2, a system, such as the system 100, detects escape zone information for a group of vehicles including vehicles 251-254. In an example shown in FIG. 2, for the vehicle 251, the system detects three escape zones including an escape route (e.g., a right lane) to the right of the vehicle 251, a front vehicle gap, and a rear vehicle gap. The system outputs a message 261 indicating that the escape route is available to the right of the vehicle 251, the front vehicle gap being “OK”, and the rear vehicle gap being “Good”. For the vehicle 251, the system detects three escape zones including an escape route (e.g., a left shoulder) to the left of the vehicle 252, a front vehicle gap, and a rear vehicle gap. The system outputs a message 262 indicating that the escape route is available to the left of the vehicle 252, the front vehicle gap being “Good”, and the rear vehicle gap being “Good”. For the vehicles 253-254, the system detects two escape zones including a front vehicle gap and a rear vehicle gap. The system outputs a message 263 indicating that no escape route is available to the vehicles 253-254, the front vehicle gap being “OK”, and the rear vehicle gap being “Good”. Further, as no escape route is available to the vehicles 253-254, the system further displays a message 264 to alert drivers of the vehicles 253-254.

The system 100 can be configured to predict accidental situations and help preventing accidents by detecting and monitoring (or predicting) the escape zone information of the group of vehicles 101-106. In some examples, the escape zone information includes escape route(s) for one or more of the group of vehicles 101-106, and the system 100 is referred to as a cooperative detection and monitoring system of vehicle escape routes. Thus, a number of accidents caused by drivers’ inability or lack of mindfulness to find an escape zone (e.g., an escape route) while driving can be reduced. The system 100 can automatically determine the escape zone information (e.g., escape routes) in different driving conditions and alert the drivers of the group of vehicles 101-106 about the escape zone information (e.g., no escape zone, no escape route, one or more escape zones being compromised, one or more escape routes being compromised). The system 100 can coordinate with the group of vehicles 101-106. In an example, the system 100 is configured to ensure that no vehicle in the group of vehicles 101-106 has a compromised escape zone (or a compromised escape route). In an example, the system 100 is configured to ensure that each of the group of vehicles 101-106 has an escape zone available at all times.

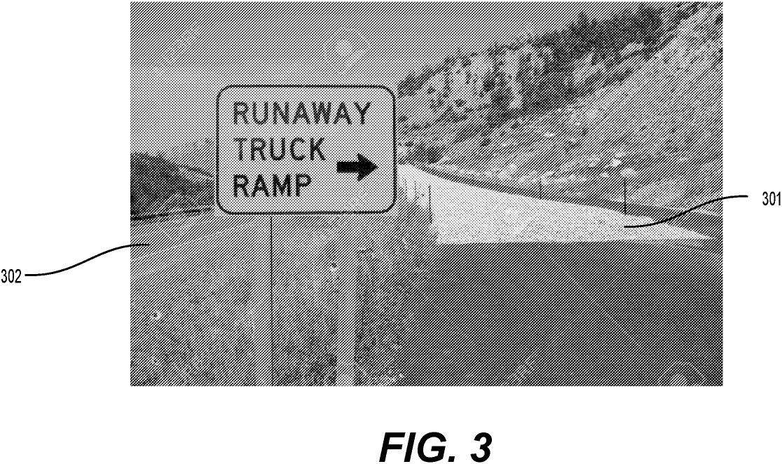

In some situations, escape routes are provided on roadways. FIG. 3 shows an example of an escape route 301 according to an embodiment of the disclosure. Vehicles, such as trucks, can have an escape route 301 on a highway. In an example shown in FIG. 3, the escape route 301 is a runaway truck ramp that is to the right of the highway. However, escape routes may not be available when an accidental situation occurs. Further, escape routes may not be available for certain vehicles, such as cars and motorcycles in some examples.

In some examples, being able to detect and/or predict (or anticipate) accidental situations can help avoid an accident. For example, when driving in a residential area, constantly looking out for children and pets that may suddenly dart out of houses and onto the road is helpful to avoid an accident. For highway driving, monitoring brake failures, abrupt lane changes by other cars, and the like, is helpful avoid an accident. However, drivers may not monitor accidental situations as described above, for example, due to lack of skills and/or experience, a stressful situation or a mental state.

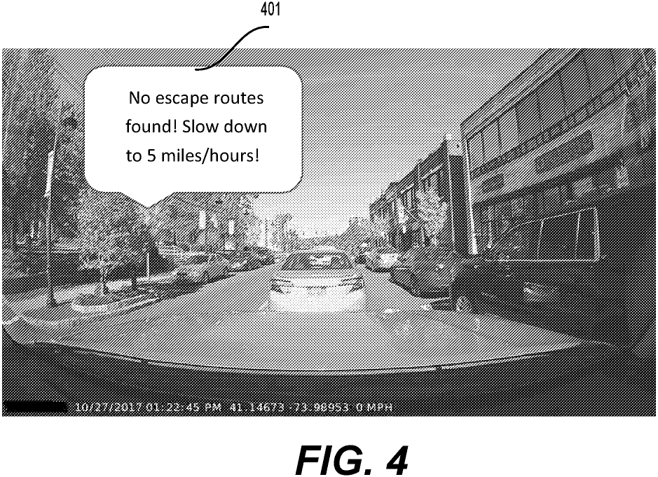

The system 100 can be an automated system that is configured to constantly detect hazards and determine escape zones or escape routes to avoid accidental situations and thus to avoid accidents. FIG. 4 shows an example of detecting escape zone information in a residential area according to an embodiment of the disclosure. Referring to FIG. 4, no escape routes are detected by the system 100 for a vehicle, and a message 401 is displayed to alert a driver of the vehicle to slow down to 5 miles per hour in the residential area.

On highway traffic, the system 100 can search for escape zones (e.g., escape routes, vehicle gaps), for example, continuously. In an example, if the system 100 finds at least one escape route, the system 100 indicates the escape zone status as ‘Ok’; otherwise, for example, if no escape route is detected, the system 100 triggers a message and alert a driver that there are no escape routes and the driver may need to change a speed and/or a location of the vehicle to create escape route(s), such as that described with reference to FIG. 2.

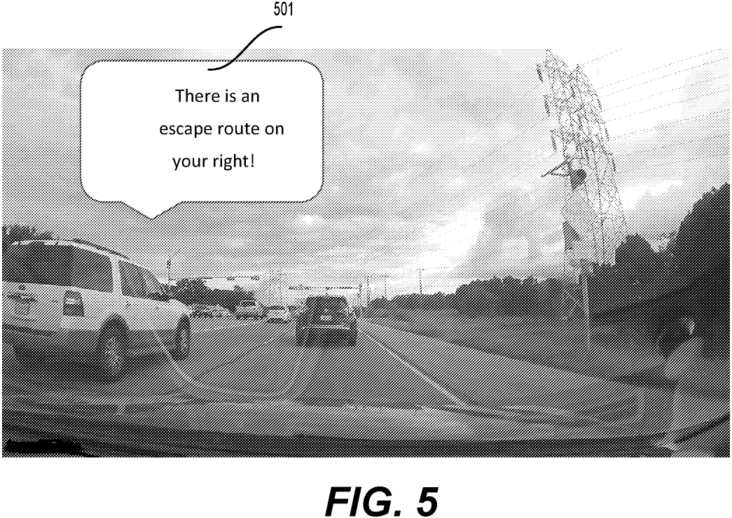

FIG. 5 shows an example of detecting escape zone information on a highway according to an embodiment of the disclosure. Referring to FIG. 5, no escape route to the right of a vehicle is detected by the system 100, and a message 501 is displayed to alert a driver of the vehicle that no escape route is available to the right of the vehicle.

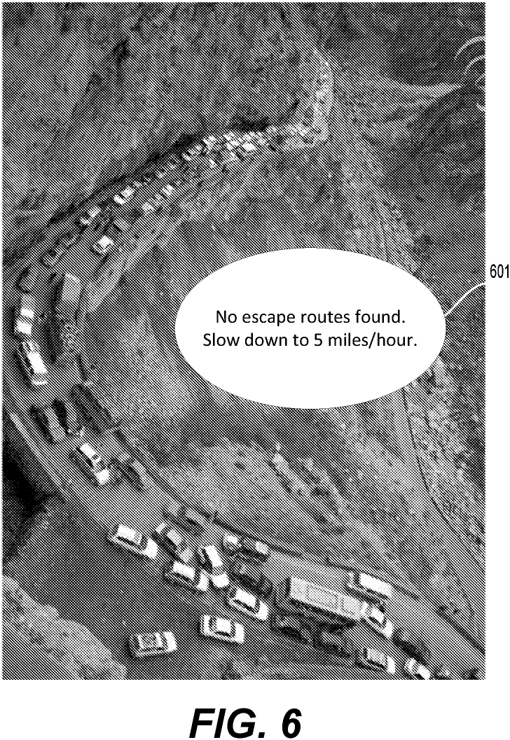

In some examples, such as in mountainous driving, it can be more critical to detect and/or predict escape route(s). FIG. 6 shows an example of detecting escape zone information in mountainous driving according to an embodiment of the disclosure. Referring to FIG. 6, no escape route of a vehicle is detected by the system 100, and a message 601 is displayed to alert a driver of the vehicle that no escape route is available to the vehicle.

The system 100 can be configured to detect and/or predict escape zone information for the group of vehicles 101-106 using artificial intelligence (AI), such as an artificial neural network (or neural network). In an example, the AI is based on a machine learning (ML) algorithm.

The system 100 can include a cloud 300 that has a controller (also referred to as a centralized controller or a central controller) 301 and a controller (also referred to as a decentralized controller or a local controller) 211. The centralized controller or processing circuitry 301 can be configured to detect escape zone information for first multiple vehicles in real-time and to predict escape zone information for second multiple vehicles. The centralized controller 301 (e.g., processing circuitry) can further include a real-time processing module 311 and a batch processing module 313. The real-time processing module 311 can be configured to detect escape zone information for the first multiple vehicles in real-time. The first multiple vehicles can include a plurality of groups of vehicles. In an example, the first multiple vehicles include the vehicles 101-106. The batch processing module 313 can be configured to predict escape zone information for the second multiple vehicles. The second multiple vehicles a plurality of groups of vehicles. In an example, the second multiple vehicles include the vehicles 101-106. The first multiple vehicles can be identical to or different from the second multiple vehicles.

The controller 211 (e.g., processing circuitry) can be located in a location such that the controller 211 can communicate with the group of vehicles 101-106. In an example, the controller 211 is located in or is attached to the vehicle 101. The controller 211 is configured to track speeds of the vehicles 101-106 and maintain escape zone(s) in a longitudinal direction (e.g., a direction that is in front of a vehicle or behind a vehicle) and a lateral direction (e.g., to the left of the vehicle or to the right of the vehicle) with respect of each vehicle in the group of vehicles 101-106.

The controller 301 in the cloud 300 is configured to optimize the performance of the controller 211. The controller 301 can correct error(s) of the controller 211. The controller 301 can ingest data from a large number of vehicles and optimize a plurality of decentralized controllers such as controllers 211-216 by AI.

Referring to FIG. 1A, the system 100 can further include one or more sub-systems, such as sub-systems 191-196. In an example shown in FIG. 1A, the sub-systems 191-196 include controllers 211-216, respectively. In an example, the sub-systems 191-196 are attached to the respective vehicles 101-106, and the controllers 211-216 are attached to the respective vehicles 101-106. In some other examples, one or more of the controllers 211-216 are outside the respective vehicles 101-106, and are configured to communicate with the respective vehicles 101-106, for example, via interface circuitry. A vehicle 107 does not have a controller that can detect escape zone status, and thus is not part of the group of vehicles 101-106.

FIG. 1B shows an example of the sub-system 191 according to an embodiment of the disclosure. The sub-system 191 can include driving environment sensor(s) 110, vehicle condition sensors 125, interface circuitry 150, the controller 211, and memory 140 that are coupled together, for example, using a bus 150. The vehicle condition sensors 125 can include motion sensor(s) 120, driving activity sensor(s) 160, tire sensor(s) 161, and/or the like.

One or more components in the sub-system 191 can be attached to the vehicle 101. Alternatively, certain components (e.g., the tire sensor(s) 161) of the sub-system 191 can be located in or attached to the vehicle 101 and certain components (e.g., the controller 211) of the sub-system 191 can be located remotely in a server that can communicate with the vehicle 101 wirelessly.

The driving environment sensor(s) 110 can determine driving environments for the group of vehicles. The driving environment of a vehicle (e.g., the vehicle 201) can include an environment surrounding the vehicle or affecting an operation of the vehicle. The driving environment of the vehicle can include one or more of a road condition of a road, a road type of the road, a weather condition, and/or the like for the vehicle. The road condition of the road can indicate one of: dryness, quality (e.g., whether a pothole is on the road), or curvature (e.g., whether the road is straight) of the road. The road type of the road can indicate a speed limit of the road, whether the road is a highway, a local road, a mountainous road, a road in a residential area, and/or the like, whether the road is a two-way road, a one-way road, and/or the like.

The driving environment sensor(s) 110 can include cameras 111, ranging devices 112, and/or the like. The camera 111 can be any suitable devices that can obtain images or videos. The camera 111 can capture different views around the vehicle 101. The camera 111 can be fixed to the vehicle 101. The camera 111 can be detachable, for example, the camera 111 can be attached to, removed from, and then reattached to the vehicle 101. The camera 111 can be positioned at any suitable locations of the vehicle 101. The camera 111 can be oriented toward any suitable directions. Accordingly, the camera 111 can obtain images or videos that show different portions of a surrounding environment of the vehicle 101. The different portions of the surrounding environment can include a front portion that is in front of the vehicle 101, a rear portion that is behind the vehicle 101, a right portion that is to the right of the vehicle 101, a left portion that is to the left of the vehicle 101, a bottom portion that shows an under view of the vehicle 101, a top portion that is above the vehicle 101, and/or the like. Accordingly, a front view, a rear view, a left view, a right view, a bottom view, and a top view can show the front portion, the rear portion, the left portion, the right portion, the bottom portion, and the top portion of the surrounding environment, respectively. For example, the bottom view can show a tire, a pothole beneath the vehicle 101, or the like. Different portions, such as the left portion and the bottom portion, can overlap. Additional views (e.g., a right-front view, a top-left view) can be obtained by adjusting an orientation of a camera, by combining multiple camera views, and thus show corresponding portions of the surrounding environment. An orientation of a camera can be adjusted such that the camera can show different portions using different orientations.

Each of the cameras 111 can be configured to have one or more field of views (FOVs) of the surrounding environment, for example, by adjusting a focal length of the respective camera 111 or by including multiple cameras having different FOVs in the camera 111.

The ranging devices 112 can be configured to measure distances between objects, e.g., a distance between a target and a reference point, such as a point associated with a ranging device. The ranging devices 112 can include multiple devices that provide complementary distance information, such as stereo cameras, radars, light detection and ranging devices (LIDARs), ultrasonic sensors, and the like. In an example, an image can be generated by a ranging device to show distances from a reference point to points (or targets) in the image.

Additional devices, such as microphones, can be used to collect additional data. The microphones can detect various sound signals, such as sounds from a fire engine, an ambulance, a police car, winds, rain, and the like. In an example, motion of a sound source including a velocity and a position of the sound source can also be obtained, for example, using multiple microphones.

In an embodiment, the cameras 111, the ranging devices 112, and/or additional devices, such as microphones can be configured to collect complementary data of the driving environment of a vehicle. For example, the cameras 111 and the ranging devices 112 can be used to collect images and distance information of a driving environment, respectively. In another example, images from the cameras 111 and sound information from the microphones can be used to determine certain driving environment, for example, a fire engine coming from behind the vehicle.

The vehicle condition sensors 125 can determine vehicle conditions of the vehicle, such as one or more of a brake condition, a tire condition, acceleration, and a speed of the vehicle.

The motion sensors 120 can include any suitable devices configured to obtain motion of the vehicle (e.g., the vehicle 101), such as acceleration, velocity, and position of the vehicle. Accordingly, a speed and a moving direction of the vehicle can be obtained. In an example, the motion sensors 120 can include a receiver and an inertia measurement unit (IMU). In an example, the receiver can receive positioning information from various satellite-based positioning systems such as a global positioning system (GPS), and determine a position of the vehicle. In some examples, the position can be a physical address, the latitude and longitude coordinates of a geographic coordinate system used by satellite-based positioning systems such as a GPS, and the like. The IMU is a platform having multiple gyroscopes and accelerometers fixed to the vehicle, and can provide information on rotational and linear motions of the platform. The information is then used to obtain motion of the vehicle. Note that the IMU can provide a position of the vehicle when a reference position of the vehicle, such as a position when the IMU starts to operate, is given. In an example, the reference position of the vehicle can be obtained from the receiver or entered manually.

The driving activity sensors 160 can include any suitable sensors that detect data related to driving activities of the vehicle, such as accelerating, braking, steering, and the like. In an example, the driving activity sensors 160 include a brake sensor that detects the brake condition, such as braking activities and/or brake information associated with brakes of the vehicle.

The driving environment sensors 110, the motion sensors 120, the interface circuitry 150, the driving activity sensors 160, and the like, can be configured to collect complementary data. In addition, the driving environment sensors 110, the motion sensors 120, the interface circuitry 150, the driving activity sensors 160, and the like, can be configured to collect redundant data, thus, if certain devices malfunction, data can be collected by other devices.

The tire sensors 161 can monitor respective tire conditions or tire performance of tires. The tire condition of a tire can include tire pressure, tire wear, whether the tire is flat, and/or the like.

The interface circuitry 150 can be configured to communicate with any suitable device or a user of the vehicle 101 using any suitable communication technologies, such as wired, wireless, fiber optic communication technologies, and any suitable combination thereof.

The interface circuitry 150 can include wireless communication circuitry 155 that is configured to wirelessly receive data from and transmit data to, mobile phone(s), server(s) (e.g., a cloud (e.g., the cloud 300) including multiple servers, a dedicated server), wireless communication circuitry in vehicle(s) (e.g., using vehicle-to-vehicle (V2V) communication), wireless communication circuitry in infrastructure(s), such as a cloud services platform, (e.g., using vehicle-to-infrastructure (V2X or V2I) communication), wireless communication circuitry in one or more third-parties, map data service(s), and/or the like. The map data service(s) can provide any suitable data, such as map data. The map data can also include real time information indicating, for example, real time traffic and road condition.

In an example, wireless technologies used by the wireless communication circuitry 155 can include IEEE 802.15.1, IEEE 802.11, mobile network technologies such as global system for mobile communication (GSM), universal mobile telecommunications system (UMTS), long-term evolution (LTE), fifth generation mobile network technology (5G) including ultra-reliable and low latency communication (URLLC), sixth generation mobile network technology (6G), a mobile network technology beyond 6G, and/or the like. Referring to an example in FIG. 1A, the controllers 211 and 301 can communicate via a 5G network 180. The controllers 211 and 301 can communicate via any suitable network using any suitable wireless communication technologies, such as described above.

The interface circuitry 150 can include any suitable individual device or any suitable integration of multiple devices such as touch screens, keyboards, keypads, a mouse, joysticks, microphones, universal series bus (USB) interfaces, optical disk drives, display devices, audio devices (e.g., speakers), and the like. The display device can be configured to display images/videos captured by one of the cameras 111. The display device can be configured to display an output from the controller 211.

The interface circuitry 150 can also include circuitry that converts data into electrical signals and send the electrical signals to the controller 211. The interface circuitry 150 can also include circuitry that converts electrical signals from the controller 211 to the data, such as visual signals including text messages used by a display device, audio signals used by a speaker, and the like. For example, the interface circuitry 150 can be configured to output an image on an interactive screen and to receive data generated by a stylus interacting with the interactive screen.

The interface circuitry 150 can be configured to output data, such as the escape zone information for the group of vehicles 101-106 determined by the controller 211, to the user of the vehicle 101. In an example, the interface circuitry 150 outputs the escape zone information for the vehicles 101 to the user of the vehicle 101.

The interface circuitry 150 can be configured to receive data associated with the escape zone information for the group of vehicles 101-106. The data associated with the escape zone information for the group of vehicles 101-106 can indicate driving environments for and vehicle conditions of other vehicles, similar as those described above with reference to FIG. 1B.

The interface circuitry 150 can be configured to receive routing data for routing the vehicle 101. In an example, the interface circuitry 150 can receive positioning information from various satellite-based positioning systems such as a global positioning system (GPS), and determine a position of the vehicle 101. In some examples, the position can be a physical address, the latitude and longitude coordinates of a geographic coordinate system used by satellite-based positioning systems such as a GPS, and the like.

The controller 211 can be configured to detect the escape zone information for the group of vehicles, such as the vehicles 101-106. The controller 211 can include a preprocessing module 131, a cooperative escape zone module 133, and a training module 135.

The controller 211 can obtain input data associated with driving condition information for the group of vehicles (e.g., the vehicles 201-206). The driving condition information can indicate driving environments and vehicle conditions of the group of vehicles (e.g., the vehicles 201-206). The driving environment of a vehicle (e.g., the vehicle 201) can include an environment surrounding the vehicle or affecting operation of the vehicle. The driving environment of the vehicle can include one or more of a road condition of a road, a road type of the road, a weather condition, and/or the like for the vehicle. The driving environment of a vehicle can be obtained by the driving environment sensor(s) 110 for the vehicle, the interface circuitry 150 for the vehicle, memory 140, and/or the like. For example, the driving environment of the vehicle can be obtained by driving environment sensor(s) for other vehicle(s) via the interface circuitry 150 for the vehicle. The vehicle condition of the vehicle can be obtained by the vehicle condition sensors 125 of the vehicle, the interface circuitry 150 for the vehicle, the memory 140, and/or the like. For example, the speed and/or acceleration of the vehicle may be obtained from sensors on another vehicle via the interface circuitry 150.

The preprocessing module 131 can preprocess the input data associated with the driving condition information for the group of vehicles. Certain input data may be incomplete, may be skewed, have a relatively large noise, and/or the like. The preprocessing module 131 can remove or reduce the above defects in the input data. Further, the preprocessing module 131 can extract features, for example, using AI (e.g., ML algorithm). The features are associated with escape zone detection and/or prediction, such as obstacles (another vehicle, pedestrians, a pothole, and/or the like in an image or a video). Output data from the preprocessing module 131 can be input to the cooperative escape zone module 133 where the escape zone statuses for the group of vehicles are detected and/or predicted.

According to an embodiment of the disclosure, for each vehicle in the group of vehicles (e.g., the vehicles 201-206), the controller 211 (e.g., the cooperative escape zone module 133) is configured to determine, based on the driving environment of the vehicle, one or more distances associated with the vehicle that are between the vehicle and one or more obstacles that surround the vehicle.

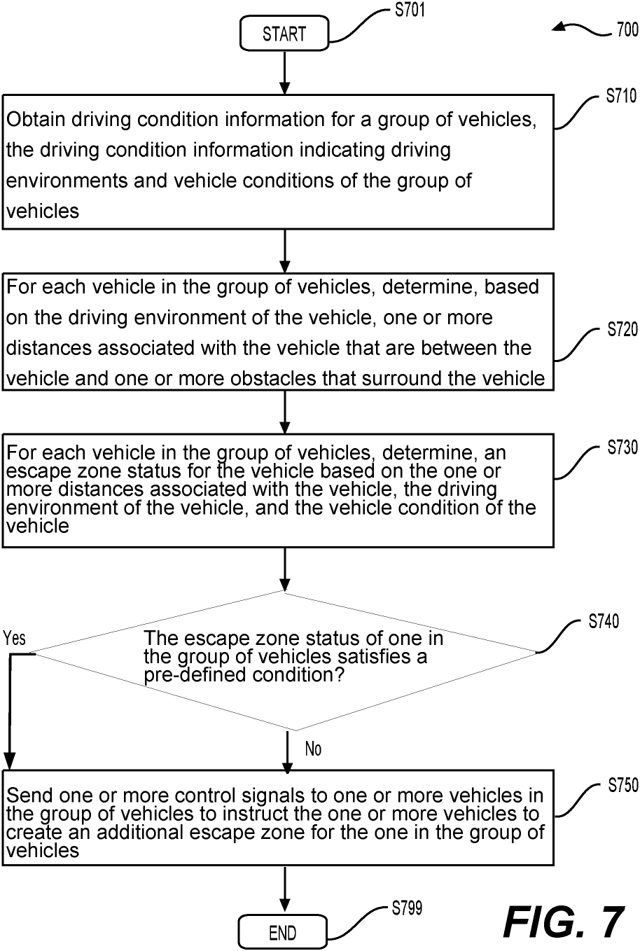

FIG. 7 shows a flowchart outlining an exemplary process 700 according to an embodiment of the disclosure. In an example, the process 700 can be implemented using the controller 211 shown in FIGS. 1A-1B or the controller 301 shown in FIG. 1A. In an example, the controller 211 is located in the vehicle 101, and the process 700 is referred to as an in-vehicle (or V only) process. Alternatively, the controller 301 is located in the cloud 300, and the process 700 is referred to as a V2C and C2V process. The process 700 can be used to determine escape zone information of a vehicle or a group of vehicles. For purposes of brevity, descriptions are given for the controller 211, and the descriptions can be suitably adapted to any suitable controller or device. The process 700 starts at S701 and proceeds to S710.

At S710, driving condition information for a group of vehicles can be obtained. The driving condition information can indicate driving environments and vehicle conditions of the group of vehicles (e.g., the vehicles 101-106), as described above with reference to FIGS. 1A-1B. The vehicle condition of a vehicle can include one or more of a brake condition, a tire condition, and a speed of the vehicle. The driving environments can include one or more of at least one road condition, at least one road type, and a weather condition for the group of vehicles.

In an example, the group of vehicles travels on at least one road, the at least one road condition of the at least one road indicates one of: dryness, quality, or curvature of the at least one road, and the at least one road type of the at least one road indicates at least one speed limit of the at least one road.

At S720, for each vehicle (e.g., the vehicle 101) in the group of vehicles (e.g., the vehicles 101-106), one or more distances associated with the vehicle that are between the vehicle and one or more obstacles that surround the vehicle can be determined based on the driving environment of the vehicle, as described above with reference to FIGS. 1A-1B.

In an example, the one or more distances are determined using an artificial intelligence algorithm, such as an artificial neural network, a ML algorithm, or the like.

At S730, for each vehicle in the group of vehicles, an escape zone status for the vehicle can be determined based on the one or more distances associated with the vehicle, the driving environment of the vehicle, and the vehicle condition of the vehicle, as described above with reference to FIGS. 1A-1B.

A threshold distance can be determined based on one or more of a respective one of the at least one road condition, a respective one of the at least one road type, the weather condition, and the vehicle condition for the vehicle. Further, whether the one or more escape zones are available to the vehicle can be determined based on a comparison of the one or more distances and the threshold distance.

In an embodiment, each vehicle in the group of vehicles is associated with four sides that include a front side, a rear side, a left side, and a right side. The one or more obstacles includes a front obstacle, a rear obstacle, a left obstacle, and a right obstacle, the one or more distances associated with the vehicle include a front distance, a rear distance, a left distance, and a right distance between the vehicle and the front obstacle, the rear obstacle, the left obstacle, and the right obstacle, respectively. For each vehicle in the group of vehicles, whether the escape zone is available for each of the four sides can be determined based on a comparison of the front distance, the rear distance, the left distance, and the right distance with the threshold distance. The escape zone status that indicates a number of escape zones available to the vehicle and/or a location of an escape zone can be determined.

At S740, whether the escape zone status of one in the group of vehicles satisfies a pre-defined condition can be determined as described above with reference to FIGS. 1A-1B. In an example, the pre-defined condition includes one or more of (i) a number of escape zones for each of the group of vehicles exceeds a threshold number, or (ii) one or more locations of the one or more escape zones are located at pre-defined locations.

In an example, if the escape zone status of the one in the group of vehicles is determined to have satisfied the pre-defined condition, the process 700 proceeds to S700 and terminates. If the escape zone status of the one in the group of vehicles is determined not to have satisfied the pre-defined condition, the process 700 proceeds to S750.

At S750, one or more control signals can be sent to one or more vehicles in the group of vehicles to instruct the one or more vehicles to create an additional escape zone for the one in the group of vehicles.

In an example, the one or more vehicles includes a plurality of vehicles in the group of vehicles, the one or more control signals includes a plurality of signals of the plurality of vehicles, and the plurality of signals can be sent to the plurality of vehicles, respectively.

In an example, the one or more vehicles include the one in the group of vehicles.

The process 700 can be suitably modified. Step(s) can be added, omitted, and/or combined. An order of implementing steps in the process 700 can be adapted. In certain advanced vehicles having an advanced assisted drivign system (ADAS), the ADAS of can automatically make necessary adjustments (e.g., changing speed or a lane of the vehicle) to have an escape zone (e.g., an escape route) available to the vehicle. In case the ADAS cannot find an escape zone for the vehile, the ADAS can send an alarm and/or message to the driver of the vehicle. In some examples, a plurality of ADASs can automatically make necessary adjustments (e.g., changing speed or a lane of one or more vehicles) to have escape zones (e.g., escape routes) available to a groupl of vehicle.

The escape zone statuses of the group of vehicles 101-106 can be displayed or sent to respective drivers of the group of vehicles 101-106. In an example, the escape zone status of each vehicle in the group of vehicles 101-106 is displayed or updated when the escape zone status changes (e.g., the escape zone status is different from the escape zone status detected previously).

The process 700 can be adapted to include a training step or a modifying step to modify an AI algorithm, as described above with reference to FIGS. 1A-1B. For example, a training dataset including learning samples, such as driving condition information of multiple vehicles and corresponding distances associated with each of the multiple vehicles can be obtained. The corresponding distances can be between the vehicle and obstacles that surround the vehicle. The artificial neural network can be modified based on the training dataset.

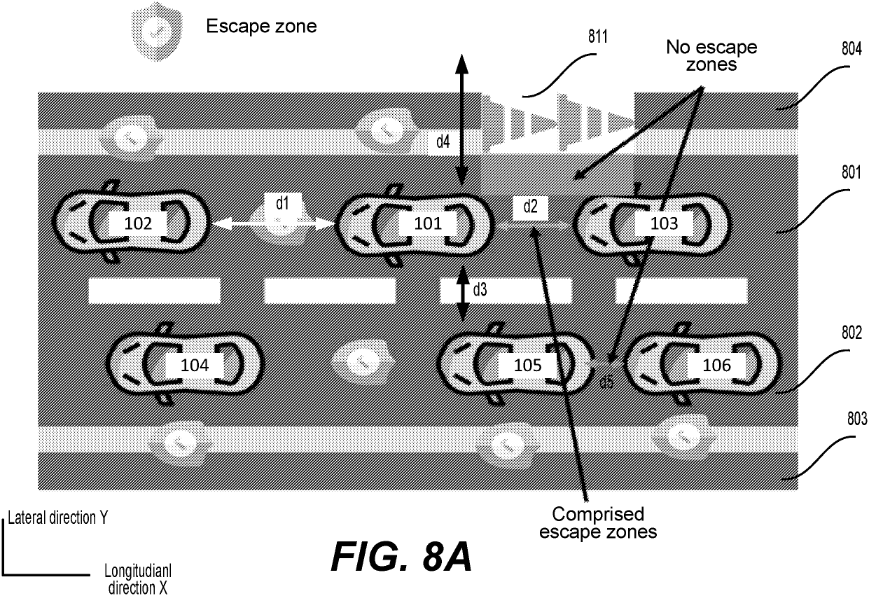

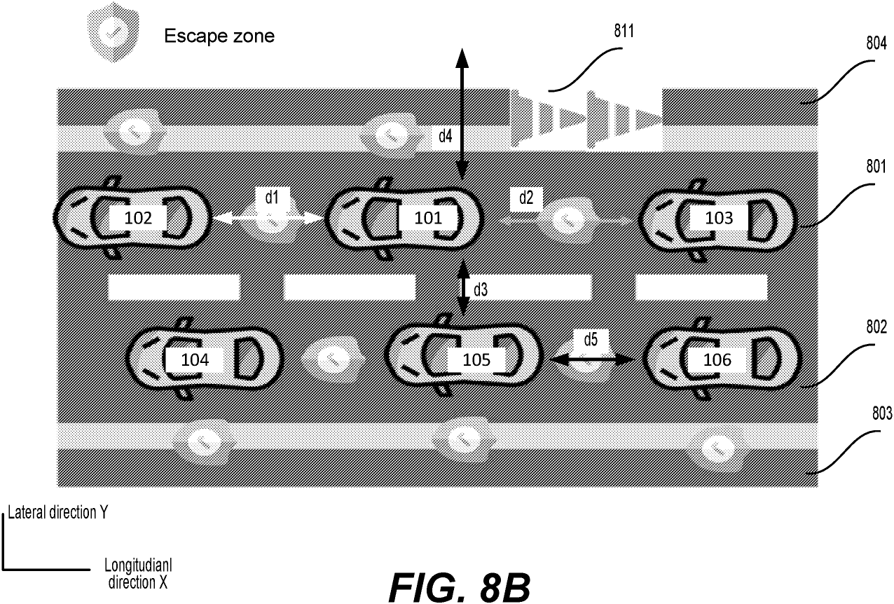

FIG. 8A shows an example of cooperative escape zone determination for a group of vehicles according to an embodiment of the disclosure. The group of vehicles includes the vehicles 101-106 driving on two lanes 801-802 of a highway. The vehicles 101-103 drive on the lane 801. The vehicles 104-106 drive on the lane 802. Lanes 803-804 are shoulders of the highway. The description below focuses on the vehicle 101, however, the description can be suitably adapted to other vehicles, such as the vehicles 102-106.

For the vehicle 101, the controller 211 (e.g., the cooperative escape zone module 133) can be configured to determine four distances d1-d4 that are between the vehicle 101 and obstacles that surround the vehicle 101. More specifically, d1 is the distance between the vehicle 101 and a front obstacle (i.e., the vehicle 102) in front of the vehicle 101 and is referred to as the front distance; d2 is the distance between the vehicle 101 and a rear obstacle (i.e., the vehicle 103) behind the vehicle 101 and is referred to as the rear distance; d3 is the distance between the vehicle 101 and a left obstacle (e.g., a fence for the shoulder 803, not shown) to the left of the vehicle 101 and is referred to as the left distance; and d4 is the distance between the vehicle 101 and a right obstacle (e.g., a fence for the shoulder 804, not shown) to the right of the vehicle 101 and is referred to as the right distance.

Similarly, the controller 211 (e.g., the cooperative escape zone module 133) can be configured to determine distances associated with the vehicles 102-106. Certain distances associated with adjacent vehicles can be identical, and thus the controller 211 can reuse the certain distances without determining the certain distances again. For example, the distance d1 between the vehicles 101-102 is the front distance for the vehicle 101 and also a rear distance for the vehicle 102. Accordingly, if d1 is determined for the vehicle 101, the controller 211 does not need to determine the rear distance for the vehicle 102.

For each vehicle in the group of vehicles, the controller 211 (e.g., the cooperative escape zone module 133) is configured to determine an escape zone status for the vehicle based on the one or more distances associated with the vehicle, the driving environment of the vehicle, and the vehicle condition of the vehicle. According to an embodiment, the controller 211 (e.g., the cooperative escape zone module 133) determines a threshold distance based on one or more of the road condition, the road type, the weather condition, and the vehicle condition for the vehicle. For example, the threshold distance can decrease when the road condition is better (e.g., the road is flat, dry, straight, free from potholes, and/or the like), when a speed limit of the road decreases, when the weather condition is better (e.g., a sunny day instead of a raining day), and/or the like. The threshold distance can decrease if the brake condition and the tire condition are better. The threshold distance can decrease if the speed of the vehicle decreases. The threshold distance can be different for different vehicles or different for different speeds of the vehicle. The threshold distance used for the longitudinal direction X can be identical to or different from the threshold distance used for the lateral direction Y.

Further, the controller 211 (e.g., the cooperative escape zone module 133) determines whether the one or more escape zones are available to the vehicle based on a comparison of the one or more distances and the threshold distance.

Referring back to FIG. 8A, the controller 211 (e.g., the cooperative escape zone module 133) is configured to determine the escape zone status for each of the vehicles 101-106. For example, for the vehicle 101, the controller 211 determines the threshold distance as described above. In an example, the threshold distance for the longitudinal direction X and the lateral direction Y is identical. The controller 211 determines whether escape zone(s) are available to the vehicle 101 by comparing distances d1-d4 with the threshold distance. For example, d1 and d4 are larger than the threshold distance, and thus escape zones are available in front of and to the right of the vehicle 101. D2 is equal to the threshold distance, and thus a comprised escape zone is available to behind the vehicle 101. D3 is less than the threshold distance, and thus no escape zone is available to the left of the vehicle 101. Similarly, the controller 211 can determine the escape zone statuses for vehicles 102-106, respectively, and the escape zone statuses for vehicles 102-106 are shown in FIG. 8A. For the vehicle 103, an obstacle (e.g., a construction area) is to the right, and a distance between the obstacle and the vehicle 103 is less than the threshold distance, and thus no escape zone is available to the right of the vehicle 103. A distance d5 between the vehicles 105-106 is less than the threshold distance, and thus no escape zone is available between for the vehicles 105-106.

The escape zone status can indicate a number of escape zones available to the vehicle and/or a location of an escape zone. The controller 211 (e.g., the cooperative escape zone module 133) can further determine whether the escape zone status of one in the group of vehicles fails to satisfy a pre-defined condition. The pre-defined condition can include one or more of (i) a number of escape zones for each of the group of vehicles exceeds a threshold number, or (ii) one or more locations of the one or more escape zones are located at pre-defined locations. The threshold number can be an integer, such as 0, 1, 2, or the like. The pre-defined location can be a left escape zone (e.g., a shoulder on a roadway, a run-away ramp, an empty lane), a right escape zone (e.g., a shoulder on a roadway, a run-away ramp, an empty lane), a front escape zone (e.g., a front distance being larger than another threshold), a rear escape zone (e.g., a rear distance being larger than the other threshold), or the like. Referring to FIG. 8A, for vehicle 101, the pre-defined location is that a number of escape zones exceeds 3. Thus, the controller 211 (e.g., the cooperative escape zone module 133) determines that the escape zone status of the vehicle 101 fails to satisfy the pre-defined condition.

The controller 211 (e.g., the cooperative escape zone module 133) can send one or more control signals to one or more vehicles in the group of vehicles to instruct the one or more vehicles to create an additional escape zone for the one in the group of vehicles. For example, the controller 211 can send a control signal to the vehicle 101, a control signal to the vehicle 103, or two control signals to the vehicle 101 and 103, respectively so as to increase the distance d2. For example, the two control signals to the vehicle 101 and 103 can instruct the vehicle 101 to increase the speed of the vehicle 101, and instruct the vehicle 103 to decrease the speed of the vehicle 103. In general, the controller 211 can send any suitable control signal(s) to respective vehicle(s) to increase d2. For example, the controller 211 can send a control signal to the vehicle 102 to change a lane so that the vehicle 101 can increase the speed without reducing d1.

In some examples, the controller 211 (e.g., the cooperative escape zone module 133) can send control signals to vehicles in the group of vehicles to instruct the vehicles to create additional escape zones when no escape zones are available or to replace comprised escape zone(s). For example, referring to FIGS. 8A-8B, the controller 211 (e.g., the cooperative escape zone module 133) send control signals to vehicles in the group of vehicles to instruct the vehicles to (i) create an escape zone to the right of the vehicle 103 and an escape zone between the vehicles 105-106 and (ii) replace the comprised escape zone between the vehicles 101 and 103 with an escape zone. Referring to FIG. 8B, d2 is enlarged to create the escape zone between the vehicles 101 and 103; d5 is enlarged to create the escape zone between the vehicles 105-106; and the vehicle 103 is moved such that the obstacle 811 no longer blocks the vehicle 103 to the right.

As shown in FIGS. 1A-1B and FIGS. 8A-8B, in addition to singleton escape zones for individual vehicles, the system 100 adds a cooperative nature to finding escape zones for a group of vehicles. Based on the cooperative system 100, the group of vehicles 101-106 can create escape zones for each other as shown in FIG. 8B.

In some examples, the controller 211 is configured to determine the escape zone status of the group of vehicles 101-106, during a first period of time. Another controller (e.g., one of 212-216) can be configured to determine the escape zone status of the group of vehicles 101-106, for example, during a different period of time (e.g., a second period of time). Further, vehicles in the group of vehicles can change, for example, the group of vehicles includes the vehicles 101-106 during the first period of time, and a new group of vehicles is formed during the second period of time, for example, due to a change in driving speeds, driving directions, and the like of the vehicles 101-106 and other vehicles.

Embodiments and methods in the disclosure can detect escape zones (e.g., escape routes) when the traffic (e.g., heavy traffic and/or reckless drivers), road conditions (e.g., wet or dry), and/or vehicle conditions (or vehicle performance) including brake failure, tire damage are such that an escape route may be necessary to avoid accidents.

Drivers may not think of escape routes in case of an impending accident that they cannot avoid with adequate braking and/or other means. The drivers could be distracted, do not have the skills, and/or the like. In advanced vehicles, the ADAS can keep vehicle gaps between vehicles, but such gaps can become compromised by other cars cutting in and then the drivers may need to recover to create a new vehicle gap and find escape routes. If creating the new vehicle gap is not feasible, at least the drivers have an escape route to fall back to.

Further, a cooperative based escape zone system using decentralized controllers (e.g., the controllers 211-216) for on the ground traffic and a cloud based centralized controller (e.g., the controller 301) to improve the performance of the decentralized controllers (e.g., the controllers 211-216) are disclosed. The centralized controller (e.g., the controller 301) can constantly learn from millions of decentralized controllers and improve the performance for detecting escape zones (e.g., detecting longitudinal and lateral escape zones).

The embodiments and the system 100 can improve safety of vehicles in case of compromised position regardless of bad traffic, reckless drivers, bad weather, failed equipment. Drivers of such vehicles can find an escape route similar to truck drivers who are provided with an escape route when a brake fails in downhill conditions.

The controller 211 can output escape zone data, such as vehicles distances, escape zone information or statuses for the group of vehicles, to the interface circuitry 150. The interface circuitry 150 can send the escape zone data to other vehicles (e.g., via V2V communication), the cloud 300 (e.g., via V2C communication), an infrastructure (e.g., via V2X communication), and/or the like. The interface circuitry 150 can also display the escape zone data, such as shown in FIGS. 2-6.

The controller 211 can be configured to detect and/or predict escape zone information for the group of vehicles 101-106 using AI, such as an artificial neural network (or a neural network).

In general, a neural network can learn and perform a data-driven task from examples, referred to as learning examples, without task specific instructions. A neural network can be based on a computational model including nodes. The nodes, interconnected by connections, can perform computational tasks. In an embodiment, a neural network can be characterized by a computational model and parameters. In an example, the parameters can include weights and thresholds associated with connections and nodes in the neural network.

In an embodiment, a neural network can be organized in multiple layers where different layers can perform different kinds of computations. The multiple layers can include an input layer having input nodes, an output layer having output nodes, and hidden layers having nodes between the input layer and the output layer. In an embodiment, the input layer can receive a signal originated from outside of the neural network. The output layer can send a result to outside of the neural network. Further, a neural network can be a deep neural network that has a relatively larger number of hidden layers than that of a shallow neural network. In an example, a neural network can be a convolutional neural network (CNN).

A computational model of a neural network can be determined by hand, search algorithms, and the like. Subsequently, the neural network can be trained using learning examples related to a certain task, such as cooperative escape zone detection/prediction. As a result, the parameters are modified repetitively when additional learning examples are used. In an embodiment, a large number of learning examples can be organized into multiple independent datasets, such as a training dataset and a validation dataset, to train and validate a neural network, thus obtain an optimal neural network.

In an embodiment, neural networks having various computational models can be trained using multiple training methods based on a training dataset having learning examples. In an embodiment, a learning example can include a signal pair having an input signal and an expected output signal, as described above. An input layer of a neural network can receive the input signal, and the neural network can subsequently generate a result via the output layer. The result can be compared with the expected output signal. In an example, the parameters of the neural network are modified or optimized to minimize a difference between the result and the expected output signal.

Therefore, the parameters of the neural network are optimized by the training dataset. Subsequently, the neural networks having various computational models can be trained to have optimized parameters. An optimal neural network can be obtained by applying the validation dataset on the neural networks, analyzing the results and the expected output signals associated with the validation dataset. The optimal neural network can then be deployed to perform a certain task, such as cooperative escape zone detection/prediction. Alternatively, performance of the optimal neural network can be further assessed by a test dataset before the optimal neural network is deployed to perform a task. In an example, the test dataset is independent from other datasets, such as the training dataset and validation dataset.

In an embodiment, the controller 211 (e.g., the cooperative escape zone module 133) can be configured to detect/predict escape zone information for a group of vehicles using an AI algorithm (e.g., a ML algorithm, a neural network). According to an embodiment of the disclosure, the AI algorithm (e.g., the ML algorithm, the neural network) can be trained using additional learning examples related to the cooperative escape zone detection/prediction. As a result, the parameters of the AI algorithm (e.g., the ML algorithm, the neural network) are modified repetitively when additional learning examples are used. The repetitive modification process can be implemented by the training module 135.

The memory 140 is configured to store a map database 141 including road maps, escape zone information 142, and programs 143. In one embodiment, information (e.g., the map database 141, the escape zone information 142, the programs 143) in the memory 140 can be modified or updated by the controller 211 or the controller 301. The modified information can also be uploaded to a cloud services platform that can provide on-demand delivery of computing power, database storage, and IT resources or shared with other vehicles, for example, using the wireless communication circuitry 165 via V2I and V2V communications, respectively.

The memory 140 can be a non-volatile storage medium. In another embodiment, the memory 140 includes both non-volatile and volatile storage media. In one embodiment, a portion of the memory 140 can be integrated into the controller 211. The memory 140 can be located locally in the vehicle 101. The memory 140 can be located remotely and communicate with the controller 211 via a wireless communication standard using the wireless communication circuitry 155.

In the FIG. 1 example, the components are coupled together by a bus architecture including a bus 150. Other suitable interconnection techniques can also be used.

One or more components of the interface circuitry 150, the controller 211, and the memory 140 can be made by discrete devices or integrated devices. The circuits for one or more of the interface circuitry 150, the controller 211, and the memory 140 can be made by discrete circuits, one or more integrated circuits, application-specific integrated circuits (ASICs), and the like. The controller 211 can also include one or more central processing units (CPUs), one or more graphic processing units (GPUs), dedicated hardware or processors to implement neural networks, and the like.

As described above, a method to detect and/or predict escape zone information can be used to reduce and/or eliminate accidents, for example, when drivers are unable to find escape zones (e.g., escape routes) as a safety mechanism on roadways. The method can be performed by any suitable controller or processing circuitry, such as the centralized controller 301 in the cloud 300, the decentralized controller 211, or the like. The decentralized controller 211 can be located in a vehicle (e.g., the vehicle 201) or outside a vehicle.

Referring back to FIG. 1A, the real-time processing module 311 in the controller 301 can be configured to detect the escape zone information of a group of vehicles (such as the vehicles 101-106), similarly as described above for the controller 211, and thus detailed description for the real-time processing module 311 is omitted for purposes of brevity. In some examples, the real-time processing module 311 may be used to detect escape zone information of a relatively large group of vehicles, and a number of vehicles in the group of vehicles associated with the real-time processing module 311 in the controller 301 is more than the group of vehicles associated with the controller 211.

The cloud 300 can include memory and/or interface circuitry. The descriptions for the memory 140 and the interface circuitry 150 can be suitably adapted to the memory and/or the interface circuitry in the cloud 300. The memory in the cloud 300 may include a much larger database, for example, database over millions of cars in millions of traffic situations worldwide used for big data analysis, than that in the memory 140.

In an example, as a number of learning samples used to train an AI algorithm (e.g., a ML algorithm, a neutral network) in the controller 301 is significantly larger than that used to train the AI algorithm (e.g., the ML algorithm, the neutral network) in the controller 211, the AI algorithm in the controller 301 can be more accurate than the AI algorithm in the controller 211. Accordingly, the AI algorithm in the controller 211 (e.g., the ML algorithm, the neutral network) may be updated (e.g., replaced or modified) by the AI algorithm (e.g., the ML algorithm, the neutral network) in the controller 301. The AI algorithm in the controller 211 may be modified by the learning samples (e.g., data associated with escape zone information) in the controller 301.

Further, the batch processing module 313 in the cloud 300 can be configured to perform a predictive analysis and detect/predict situations that may result in compromised escape zones (or comprised escape routes) or no escape zones (e.g., no escape routes) for vehicles ahead of time. The batch processing module 313 can perform big data analysis, for example, over millions of cars in millions of traffic situations worldwide. The big data analysis can include, but not limited to, traffic types, road conditions, road types, weather conditions, predictive analysis, anomaly detection, and/or the like. The predictive analysis can include prediction of potential accidental situations or traffice situations to be avoided for trip planning, for example, based on traffic patterns for certain roads in the US or in the world.

In an example, the goal of the real-time processing performed by the real-time processing module 311 is to quickly determine an escape zone status and the big data analysis by the batch processing module 313 is to perform predictive analysis to determine conditions that may lead to compromised safety situations after analyzing millions of situations of cars in traffic over different terrains.

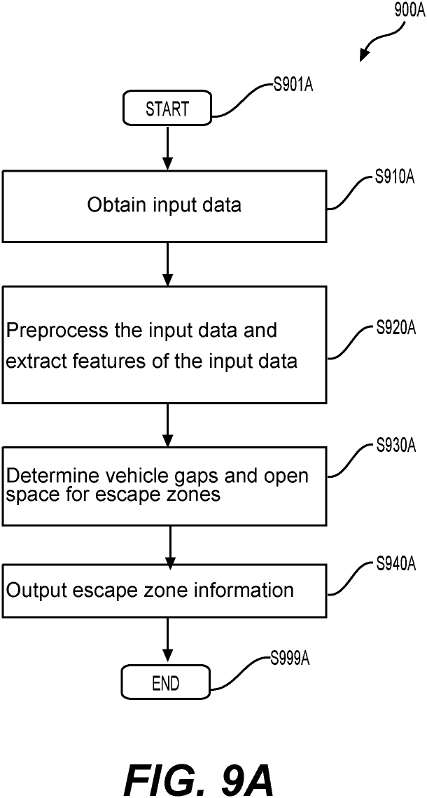

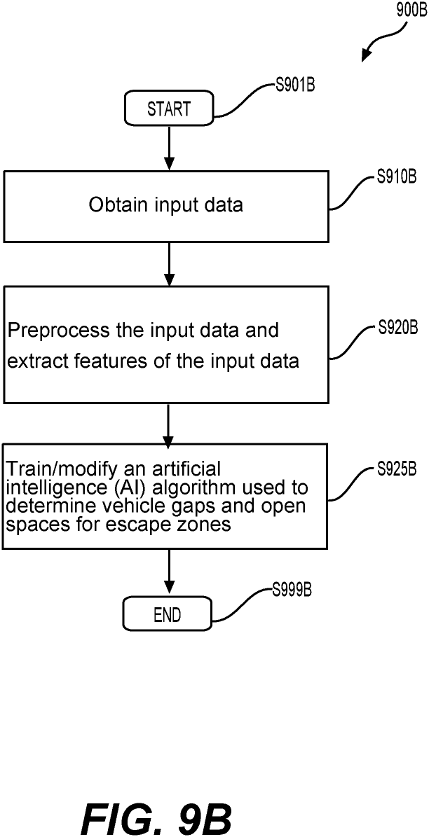

FIG. 9A shows a flowchart outlining an exemplary process 900A according to an embodiment of the disclosure. In an example, the process 900A can be implemented using the controller 211 shown in FIGS. 1A-1B. In an example, the controller 211 is located in the vehicle 101, and the process 900A is referred to as an in-vehicle (or V only) process 900A. In an embodiment, the process 900A can be used to determine escape zone information of a vehicle or a group of vehicles. For purposes of brevity, descriptions are given for the controller 211, and the descriptions can be suitably adapted to any suitable controller or device. The process 900A starts at S901A and proceeds to S910A.

At S910A, input data associated with driving condition information of one or more vehicles can be obtained, as described above with reference to FIGS. 1A-1B. In an example, vehicles, such as the vehicles 101-106, in traffic, can have cameras, lidar, radar, and/or ultrasounic sensors that are configured to obtain the input data associated with traffic conditions, road conditions, vehicle conditions (e.g., brake conditions, tire conditions).

At S920A, the input data can be preprocessed and features for escape zone information prediction can be extracted from the preprocessed input data, as described above with reference to FIGS. 1A-1B.

At S930A, vehicle gap(s) and/or open space(s) used for escape zones can be determined using an AI algorithm (or an AI processing), such as a ML processing capabilities of the controller 211, as described above with reference to FIGS. 1A-1B. The AI processing (e.g., the ML processing) can use the input data from obtained at S910A and then calculate whether in a case of an emergency, there is an escape zone (e.g., an escape route, an open space) available for the vehicle to move into and thus avoid an accident. In an example, the emergency can occur when vehicle conditions (e.g., tire(s) and/or brake performance are compromised due to, example, flat tire(s), failed brakes), vehicle gaps between vehicles are compromised or reduced due to other vehicles moving into the vehicle gaps, and/or the like. The input data can indicate surrounding obstacles (e.g., other vehicles), road conditions, vehicle gaps, surrounding open spaces, road types, brake conditions, tire conditions, and/or the like.

At S940A, the escape zone information, for example, indicating an escape zone status of the vehicle, can be output to alert a driver of the vehicle, as described above with reference to FIGS. 1A-1B. In an example, if there are no escape zones (e.g., no escape routes), the controller 211 can send out messages and alerts to the driver to lower the speed and/or change lanes until an escape route is found. The driver can ignore the messages, but at least the driver is alerted of the situation.

The process 900A can be suitably modified. Step(s) can be added, omitted, and/or combined. An order of implementing steps in the process 900A can be adapted. In certain advanced vehicles having an advanced assisted drivign system (ADAS), the ADAS of can automatically make necessary adjustments (e.g., changing speed or a lane of the vehicle) to have an escape zone (e.g., an escape route) available to the vehicle. In case the ADAS cannot find an escape zone for the vehile, the ADAS can send an alarm and/or message to the driver of the vehicle. In some examples, a plurality of ADASs can automatically make necessary adjustments (e.g., changing speed or a lane of one or more vehicles) to have escape zones (e.g., escape routes) available to a groupl of vehicle.

Comparing advanced vehicles having the ADAS with a legacy car without the ADAS, for advanced vehicles, the system 100 or the embodiments in the disclosure can provide an ADAS that can automatically guide a vehicle. For legacy vehicles, in some examples, driver may need to maneuver vehicles based on alerts and messages that are shown in FIGS. 2-6.

The process 900A can be adapted to a process 900B to include a training step or a modifying step S925B to modify an AI algorithm, as shown in FIG. 9B. FIG. 9B shows a flowchart outlining an exemplary process 900B according to an embodiment of the disclosure. In an example, the process 900B can be implemented using the controller 211 shown in FIGS. 1A-1B. In an example, the controller 211 is located in the vehicle 101, and the process 900B is referred to as an in-vehicle (or V only) process 900B. In an embodiment, the process 900B can be used to train and/or modify the AI algorithm used to determine escape zone information of a vehicle or a group of vehicles. For purposes of brevity, descriptions are given for the controller 211, and the descriptions can be suitably adapted to any suitable controller or device.

Steps S910B and S920B can be identical or similar to S910A and S920A, and thus descriptions for steps S910B and S920B are omitted for purposes of brevity. A difference between the processes 900A and 900B is S925B in the process 900B.

At S925B, the AI algorithm, such as a neural network, a ML algorithm, or the like, used to determine vehicle gaps and open spaces for escape zones can be trained and/or modified, as described above. In an example, learning samples used to train and/or modify the AI algorithm include output data from S920B where the output data can include the preprocessed input data and extracted features associated with escape zone detection.

The process 900B can be suitably modified. Step(s) can be added, omitted, and/or combined. An order of implementing steps in the process 900B can be adapted. In an example, after training/modifying the AI algorithm, the modified AI algorithm can be used to determine vehicle gap(s) and/or open space(s) for the vehicle or a group of vehicles based on additional data indicating driving condition information of the vehicle or the group of vehicles.

In some examples, the processes 900A and 900B can be implemented in a controller (e.g., the controller 211) attached to a vehicle (e.g., the vehicle 101), and thus are referred to as in-vehicle processes. Referring back to FIGS. 1A-1B, in an example, the in-vehicle processes 900A and 900B are performed in the controller 211. The in-vehicle processes that are similar to or identical to 900A and 900B can be performed in a controller in any vehicle, such as each of the controllers 212-216 in the respective vehicles 102-106.

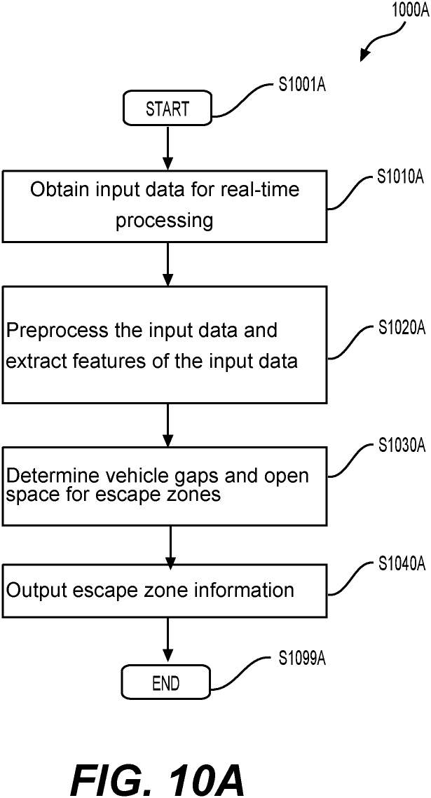

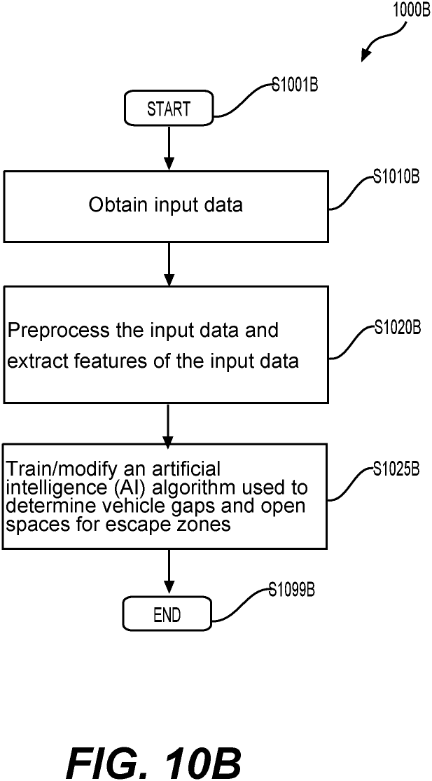

The processes 900A-900B can be suitably adapted to a vehicle-to-cloud-to-vehicle (V2C and C2V) situation as follows. The process 900A can be adapted to a process 1000A. Referring to FIG. 10A, in an example, steps S1020A, S1030A, and S1040A are identical to or similar to the steps S920A, S930A, and S940A.

In an example, the processes 1000A-1000B can be implemented using the controller 301 in the cloud 300 shown in FIGS. 1A-1B. In an example, the controller 301 is located in the cloud 301, and the processes 1000A-1000B are referred to as an vehicle-to-cloud-to-vehicle (V2C and C2V) processes. In an embodiment, the process 1000A can be used to determine escape zone information of a vehicle or a group of vehicles. The process 1000B can be used to train and/or modify the AI algorithm used to determine escape zone information of a vehicle or a group of vehicles.

At S1010A, input data associated with escape zone detection and/or big data analysis can be obtained from one or more vehicles by a cloud via V2C communication. In an example, the input data in the cloud 300 can be obtained using data ingestion with Apache Storm.

In an example, at S910A, the input data can be obtained directly from sensors on the vehicle. Alternatively, at S910A, the input data can be obtained from other vehicles via V2V communication or from the cloud 300 using C2V communication. Thus, S1010A and S910A can be different.

Another difference between the processes 1000A and 900A is that S1020A can be omitted, for example, when a controller in a vehicle is capable of performing S1020A. Thus, initial processing including the preprocessing step and/or feature extraction step can be performed in local controllers in individual vehicles, thus ensuring fast operation speed and lower cost than doing the preprocessing step and/or feature extraction step in the cloud. Further, if the preprocessing step and/or feature extraction step are performed in the local controllers in individual vehicles, the input data in S1010A include the preprocessed data and/or the extracted features instead of unprocessed raw data.

For certain vehicles that do not have sensing capabilities or computing capabilities, the cloud can still perform S1020A. In some examples, the certain vehicles that do not have sensing capabilities or computing capabilities have GPS sensors, accelerometers, and mobile devices to interact with the cloud.

The process 1000A can be suitably adapted to a process 1000B, as described above with reference to the processes 900A and 900B, and thus detailed description is omitted for purposes of brevity. In an example, steps S1010B and S1020B are similar or identical to steps S1010A and S1020A, as described above. For example, S1020B can also be performed by a local controller in an individual vehicle. Step S1025B and S925B can be similar or identical. For example, at S1025B, the AI algorithm, such as a neural network, a ML algorithm, or the like, used in the cloud to determine vehicle gaps and open spaces for escape zones can be trained and/or modified, as described above.

In some examples, the processes 1000A and 1000B can be implemented in a controller (e.g., the controller 301) in the cloud 300, and thus are referred to as V2C and C2V processes. Referring back to FIGS. 1A-1B, in an example, the processes 1000A and 1000B are performed in the controller 301 (e.g., the real-time processing module 311).

Referring to FIG. 1A, the system 100 can send messages in-vehicle (V Only) processing and perform V-only processes 900A and 900B, for example, by the controller 211. The system 100 can send messages 181 (and optional 187 and 188) from vehicle to cloud (C2V) for processing and back to vehicle (C2V). The system 100 can also send messages 182-186 between vehicles (V2V).

V-Only, V2V, V2C, and C2V messages can take advantage of low latency such as via 5G and 6G data rates. In an example, the latencies for V-Only and V2V can be less than 5 milliseconds with 5G data rates. The latencies for V-Only and V2V can reach 10 to 100 microseconds with 6G data rates. Such low latencies can be advantageous for emergency responses. Latencies for V2C and C2V can be significantly larger than those for V-Only and V2V.

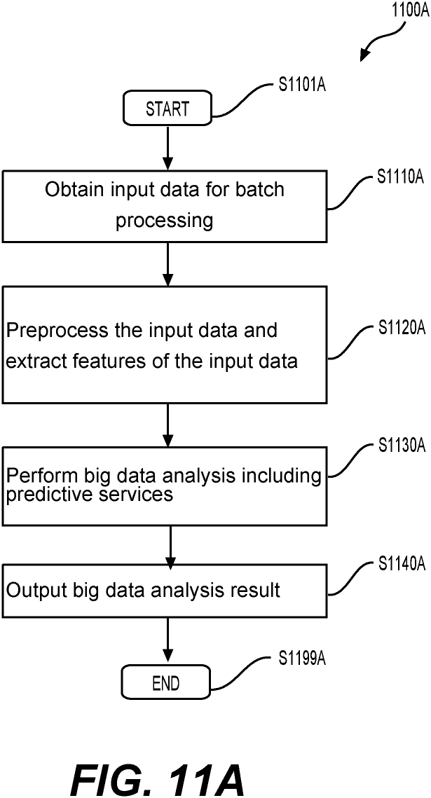

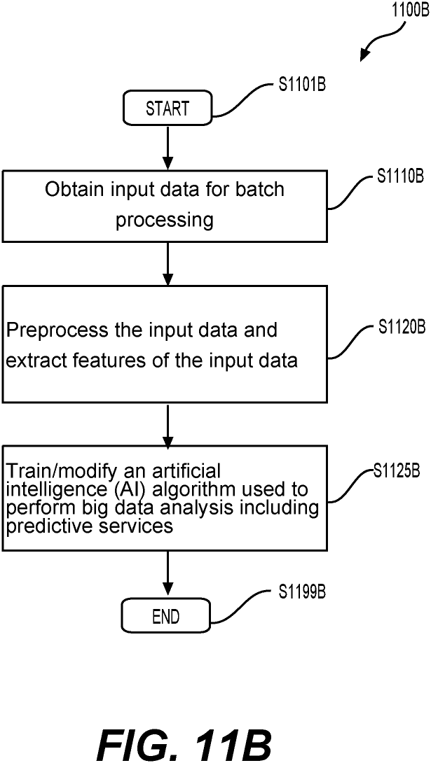

FIG. 11A shows a flowchart outlining an exemplary process 1100A according to an embodiment of the disclosure. In an example, the process 1100A can be implemented using the controller 301 shown in FIGS. 1A-1B. In an example, the controller 301 is located in the cloud 300, and the process 1100A is referred to as an V2C and C2V process 1100A. In an embodiment, the process 1100A can be used to perform big data analysis including predictive services for a larger number of vehicles. The process 1100A starts at S1101A and proceeds to S1110A.

At S1110A, input data from the larger number of vehicles, map services, weather stations, infrastructures, and/or the like for batch processing to perform big data analysis can be obtained, as described above with reference to FIGS. 1A-1B. In an example, the larger number of vehicles including, for example, the vehicles 101-106, can have cameras, lidar, radar, and/or ultrasounic sensors that are configured to obtain the input data associated with traffic conditions, road conditions (e.g., wet, dry, or the like), road types (e.g., a highway, a mountain road, a local road, or the like), vehicle conditions (e.g., brake conditions, tire conditions). The input data can also include weather condition, traffic patterns for certain roads at certain times of a day, and/or the like.

At S1120A, the input data can be preprocessed and features for big data analysis can be extracted from the preprocessed input data, as described above with reference to FIGS. 1A-1B.

At S1130A, big data analysis, such as anomaly detection, weather conditions, road types, road conditions, traffic types, and predictive analysis that can be too expensive for computing in a vehicle, can be determined using an AI algorithm (or an AI processing), such as a ML processing capabilities of the controller 301, as described above with reference to FIGS. 1A-1B.

At S1140A, the big data analysis result can be output, for example, to alert a driver of a vehicle of a potential accidental situation in the future. The controller 301 in the cloud 300 can do predictive analysis and thus detect situations ahead of time that result in compromised escape routes for vehicles. This big data analysis described above can be performed over millions of cars in millions of traffic situations worldwide.

The process 1100A can be suitably modified. Step(s) can be added, omitted, and/or combined. An order of implementing steps in the process 1100A can be adapted.

The process 1100A can be adapted to a process 1100B to include a training step or a modifying step S1125B to modify an AI algorithm, as shown in FIG. 11B. FIG. 11B shows a flowchart outlining an exemplary process 1100B according to an embodiment of the disclosure. In an example, the process 1100B can be implemented using the controller 301 shown in FIGS. 1A-1B. In an example, the controller 301 is located in the cloud 300, and the process 900B is referred to as a V2C and C2V process 1100B. In an embodiment, the process 1100B can be used to train and/or modify the AI algorithm used to perform big data analysis for a large number of vehicles.

Steps S1110B and S1120B can be identical or similar to S1110A and S1120A, and thus descriptions for steps S1110B and S1120B are omitted for purposes of brevity. A difference between the processes 1100A and 1100B is S1125B in the process 1100B.

At S1125B, the AI algorithm, such as a neural network, a ML algorithm, or the like, used to perform big data analysis for the large number of vehicles can be trained and/or modified, as described above. In an example, learning samples used to train and/or modify the AI algorithm include output data from S1120B where the output data can include the preprocessed input data and extracted features associated with big data analysis.

The process 1100B can be suitably modified. Step(s) can be added, omitted, and/or combined. An order of implementing steps in the process 1100B can be adapted. In an example, after training/modifying the AI algorithm, the modified AI algorithm can be used to perform big data analysis for the larger number of vehicles based on additional data indicating driving condition information of the large number of vehicles, the weather conditions, and/or the like.

In some examples, the processes 1100A and 1100B can be implemented in a controller (e.g., the controller 301) in the cloud 300, and thus are referred to as V2C and C2V processes. Referring back to FIGS. 1A-1B, in an example, the processes 1100A and 1100B are performed in the controller 301 (e.g., the batch processing module 313).

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A system for cooperative escape zone detection for a group of vehicles, comprising:
sensors configured to obtain driving condition information for the group of vehicles, the driving condition information indicating driving environments and vehicle conditions of the group of vehicles; and
a controller configured to:
for each vehicle in the group of vehicles,
determine, based on the driving environment of the vehicle, one or more distances associated with the vehicle that are between the vehicle and one or more obstacles that surround the vehicle; and
determine an escape zone status for the vehicle based on the one or more distances associated with the vehicle, the driving environment of the vehicle, and the vehicle condition of the vehicle, the escape zone status indicating whether one or more escape zones are available to the vehicle; and
in response to the escape zone status of one in the group of vehicles failing to satisfy a pre-defined condition, send one or more control signals to one or more vehicles in the group of vehicles to instruct the one or more vehicles to create an additional escape zone for the one in the group of vehicles.

2. The system of claim 1, wherein the vehicle condition of the vehicle comprises one or more of a brake condition, a tire condition, and a speed of the vehicle.

3. The system of claim 2, wherein
the driving environments include one or more of at least one road condition, at least one road type, and a weather condition for the group of vehicles, and
the controller is further configured to:
determine a threshold distance based on one or more of a respective one of the at least one road condition, a respective one of the at least one road type, the weather condition, and the vehicle condition for the vehicle; and
determine whether the one or more escape zones are available to the vehicle based on a comparison of the one or more distances and the threshold distance.

4. The system of claim 3, wherein
each vehicle in the group of vehicles is associated with four sides that include a front side, a rear side, a left side, and a right side,
the one or more obstacles includes a front obstacle, a rear obstacle, a left obstacle, and a right obstacle,
the one or more distances associated with the vehicle include a front distance, a rear distance, a left distance, and a right distance between the vehicle and the front obstacle, the rear obstacle, the left obstacle, and the right obstacle, respectively;
for each vehicle in the group of vehicles, the controller is further configured to:
determine whether the escape zone is available for each of the four sides based on a comparison of the front distance, the rear distance, the left distance, and the right distance with the threshold distance; and
determine the escape zone status that indicates a number of escape zones available to the vehicle and/or a location of an escape zone.

5. The system of claim 3, wherein the
group of vehicles travels on at least one road,
the at least one road condition of the at least one road indicates one of: dryness, quality, or curvature of the at least one road, and
the at least one road type of the at least one road indicates at least one speed limit of the at least one road.

6. The system of claim 1, wherein the pre-defined condition comprises one or more of (i) a number of escape zones for each of the group of vehicles exceeds a threshold number, or (ii) one or more locations of the one or more escape zones are located at pre-defined locations.

7. The system of claim 1, wherein
the one or more vehicles includes a plurality of vehicles in the group of vehicles,
the one or more control signals includes a plurality of signals of the plurality of vehicles, and
the controller is further configured to send the plurality of signals to the plurality of vehicles, respectively.

8. The system of claim 1, wherein the one or more vehicles comprises the one in the group of vehicles.

9. The system of claim 1, wherein the controller is further configured to determine the one or more distances using an artificial neural network.

10. The system of claim 9, wherein
the system further includes interface circuitry configured to obtain a training dataset including driving condition information of multiple vehicles and corresponding distances associated with each of the multiple vehicles, the corresponding distances being between the vehicle and obstacles that surround the vehicle; and
the controller is further configured to modify the artificial neural network based on the training dataset.

11. The system of claim 9, wherein
the system further includes a centralized controller having another artificial neural network, and
the controller is configured to update the artificial neural network in the controller based on the other artificial neural network.

12. The system of claim 1, wherein the controller is one of (i) a centralized controller in a cloud or (ii) a decentralized controller associated with the group of vehicles.

13. The system of claim 12, wherein
the controller is the centralized controller in the cloud,
the system further includes a decentralized controller associated with the group of vehicles, and
the decentralized controller is configured to preprocess the driving condition information to obtain the driving environments and the vehicle conditions of the group of vehicles.

14. A method for cooperative escape zone detection for a group of vehicles, comprising:
obtaining, by a controller configured for the cooperative escape zone detection for the group of vehicles, driving condition information for the group of vehicles, the driving condition information indicating driving environments and vehicle conditions of the group of vehicles;
for each vehicle in the group of vehicles,
determining, based on the driving environment of the vehicle, one or more distances associated with the vehicle that are between the vehicle and one or more obstacles that surround the vehicle; and
determining an escape zone status for the vehicle based on the one or more distances associated with the vehicle, the driving environment of the vehicle, and the vehicle condition of the vehicle, the escape zone status indicating whether one or more escape zones are available to the vehicle; and
in response to the escape zone status of one in the group of vehicles failing to satisfy a pre-defined condition, sending one or more control signals to one or more vehicles in the group of vehicles to instruct the one or more vehicles to create an additional escape zone for the one in the group of vehicles.

15. The method of claim 14, wherein the vehicle condition of the vehicle comprises one or more of a brake condition, a tire condition, and a speed of the vehicle.

16. The method of claim 15, wherein
the driving environments include one or more of at least one road condition, at least one road type, and a weather condition for the group of vehicles, and
the determining the escape zone status includes:
determining a threshold distance based on one or more of a respective one of the at least one road condition, a respective one of the at least one road type, the weather condition, and the vehicle condition for the vehicle; and
determining whether the one or more escape zones are available to the vehicle based on a comparison of the one or more distances and the threshold distance.

17. The method of claim 16, wherein
each vehicle in the group of vehicles is associated with four sides that include a front side, a rear side, a left side, and a right side,
the one or more obstacles includes a front obstacle, a rear obstacle, a left obstacle, and a right obstacle,
the one or more distances associated with the vehicle include a front distance, a rear distance, a left distance, and a right distance between the vehicle and the front obstacle, the rear obstacle, the left obstacle, and the right obstacle, respectively;
for each vehicle in the group of vehicles, the determining the escape zone status includes:
determining whether the escape zone is available for each of the four sides based on a comparison of the front distance, the rear distance, the left distance, and the right distance with the threshold distance; and
determining the escape zone status that indicates a number of escape zones available to the vehicle and/or a location of an escape zone.

18. The method of claim 14, wherein
the one or more vehicles includes a plurality of vehicles in the group of vehicles,
the one or more control signals includes a plurality of signals of the plurality of vehicles,
the sending includes sending the plurality of signals to the plurality of vehicles, respectively.

19. The method of claim 14, wherein
the determining the one or more distances includes determining the one or more distances using an artificial neural network.

20. The method of claim 19, further comprising:
obtaining a training dataset including driving condition information of multiple vehicles and corresponding distances associated with each of the multiple vehicles, the corresponding distances being between the vehicle and obstacles that surround the vehicle; and
modifying the artificial neural network based on the training dataset.
